(19) United States
(12) Patent Application Publication
(10) Pub. No.: US 2023/0015083 A1
(43) Pub. Date: Jan. 19, 2023

(54) SYSTEM AND METHOD FOR MANAGING STAFFING VARIANCES IN A CONTACT CENTER

(71) Applicant: NICE LTD., Ra'anana (IL)

(72) Inventors: Rakesh Shete, Pune (IN); Ruchika Pashine, Pune (IN)

(21) Appl. No.: 17/378,712

(22) Filed: Jul. 18, 2021

(51) Int. Cl. G06Q 10/06; G06N 20/00

(52) U.S. Cl. CPC G06Q 10/06311; G06N 20/00

(57) ABSTRACT

A computerized-method for managing staffing-variances in a contact-center is provided herein. The computerized-method includes: (i) retrieving, a plurality of forecasts and corresponding schedules of working-shifts, from a database-of-a-plurality-of-agents-with-respective-plurality-of-scheduled-working-shifts; (ii) analyzing the retrieved forecasts, by monitoring net-staffing-levels to identify one or more time-intervals, in the retrieved forecasts which have the staffing-variance; (iii) using pretrained Machine Learning models to detect one or more agents that will most likely accept one or more time-intervals from the identified one or more time-intervals to store the one or more agents in the database-of-a-plurality-of-agents-with-respective-plurality-of-scheduled-working-shifts; (iv) retrieving each detected agent from the database-of-a-plurality-of-agents-with-respective-plurality-of-scheduled-working-shifts to create a working-opportunity to amend staffing-variance in one or more time-intervals; and (v) reaching out each detected agent, by broadcasting the created working-opportunity to a computerized-device of corresponding agent, to be presented via a display unit, that is associated to the computerized-device.

### TECHNICAL FIELD

The present disclosure relates to the field of data analysis for automatic engagement of agents in a contact center to amend staffing variance in working shifts.

### BACKGROUND

Staffing variances may occur in a contact center, when scheduled working shifts, are either understaffed or overstaffed. In current contact centers' systems, there is a huge turnaround time of identifying a staffing variance, creating a recommendation of agents and getting a response back. Most of the time, either agents do not respond or do not accept opportunities to work extra hours or to take time off, to meet staffing gaps, which delays the addressing of the staffing gaps.

As part of the daily activities, workforce managers have to continuously monitor and evaluate staffing variances that may result in either the need for more agents than scheduled or let few agents to make use of time-off. In other words, it may create opportunities for agents for extra hours or for time off. Based on requirements, the workforce managers need to identify a list of adequate agents who can be contacted for the extra hours or time off, which may consume time and resources that otherwise would be utilized to meet the Service Level Agreement (SLA) that helps them serve their customers better.

Therefore, to save time and resources, the challenge is twofold, identifying time intervals that are understaffed or overstaffed and identifying and reaching out agents that will most likely take advantage of extra hours or time-off opportunities, with lesser turnaround time, i.e., a better engagement of the agents.

Accordingly, there is a need for a technical solution for managing staffing variances in a contact center.

### SUMMARY

There is thus provided, in accordance with some embodiments of the present disclosure, a computerized-method for managing staffing variances in a contact center.

Furthermore, in accordance with some embodiments of the present disclosure, the computerized-method includes: (i) retrieving, by a processor, a plurality of forecasts and corresponding schedules of working-shifts, from a database of a plurality of agents with respective plurality of scheduled-working-shifts; (ii) analyzing the retrieved forecasts, by a processor, by monitoring net-staffing-levels to identify one or more time-intervals, in the retrieved forecasts which have the staffing variance; (iii) using pretrained Machine Learning (ML) models to detect one or more agents that will most likely accept one or more time-intervals from the identified one or more time-intervals to store the one or more agents in the database of a plurality of agents with respective plurality of scheduled-working-shifts; (iv) retrieving each detected agent from the database of a plurality of agents with respective plurality of scheduled-working-shifts to create a working-opportunity to amend staffing-variance in one or more time-intervals; and (v) reaching out each detected agent, by broadcasting the created working-opportunity to a computerized-device of corresponding agent, to be presented via a display unit, that is associated to the computerized-device.

Furthermore, in accordance with some embodiments of the present disclosure, the detecting of one or more agents that will most likely accept one or more time-intervals from the identified one or more time-intervals is performed by:

for each time-interval of the identified one or more time-intervals:
(i) retrieving one or more agents that match contact-center system requirements of the time-interval from the database of a plurality of agents with respective plurality of scheduled-working-shifts;
(ii) providing the retrieved one or more agents to pretrained Machine Learning (ML) models, to predict a rank of each agent to accept the time-interval; and
(iii) storing one or more agents having a predicted rank above a preconfigured threshold in the database of a plurality of agents with respective plurality of scheduled-working-shifts.

Furthermore, in accordance with some embodiments of the present disclosure, the retrieving of the one or more agents that match contact-center system requirements of the time-interval is performed based on agent related parameters, wherein the agent related parameters include at least one of: (i) proficiency level; (ii) response time; (iii) reach out success ratio; (iv) number of reach outs in a preconfigured period of time; (v) employment status; (vi) weekly maximum overtime hours; (vii) weekly minimum and maximum number of hours for employment status; (viii) daily minimum and maximum number of hours; (ix) seniority; (x) last reach out timestamp; and (xi) number of hours missed in a shift for extra hours.

Furthermore, in accordance with some embodiments of the present disclosure, the broadcasting of the created working-opportunity is via at least one communication channel.

Furthermore, in accordance with some embodiments of the present disclosure, the at least one communication channel includes: email, Short Message Service (SMS), chat messaging, push notification and notifications within an agent web portal.

Furthermore, in accordance with some embodiments of the present disclosure, the ML models are trained to predict the rank of each agent to accept the time-interval based on working-opportunity parameters, wherein the working-opportunity parameters include at least one of: (i) working-opportunity start-time; (ii) working-opportunity end-time; (iii) shift start date and time; (iv) shift end date and time; (v) broadcasting communication channel; (vi) status of working-opportunity; (vii) response time; (viii) time zone of working-opportunity; (ix) disclaimer accepted; and (x) activity code.

Furthermore, in accordance with some embodiments of the present disclosure, the broadcasted working-opportunity includes at least one of: (i) date; (ii) time; (iii) activity type; and (iv) response options.

Furthermore, in accordance with some embodiments of the present disclosure, the response options are limited by a preconfigured period of time.

Furthermore, in accordance with some embodiments of the present disclosure, the working opportunity is overtime or time-off.

Furthermore, in accordance with some embodiments of the present disclosure, time intervals having the staffing variance are time intervals which are understaffed or overstaffed.

Furthermore, in accordance with some embodiments of the present disclosure, the monitoring of net staffing levels is performed by a computerized system that is evaluating gaps with respect to net staffing levels for each interval.

Furthermore, in accordance with some embodiments of the present disclosure, the computerized method is further receiving a response as to each broadcasted working opportunity from one or more computerized-devices of agents.

Furthermore, in accordance with some embodiments of the present disclosure, the computerized method is further providing the response to the ML models for training thereof.

Furthermore, in accordance with some embodiments of the present disclosure, the response is one of: ‘accept’, ‘reject’ or ‘no response’.

Furthermore, in accordance with some embodiments of the present disclosure, when the response is ‘accept’, the computerized method is further enabling adjustment of time span of the working-opportunity.

There is further provided, in accordance with some embodiments of the present disclosure, a computerized-system for managing staffing variances in a contact center.

Furthermore, in accordance with some embodiments of the present disclosure, the computerized system includes: a processor, a platform for Machine Learning (ML) models and a database of a plurality of agents with respective plurality of scheduled-working-shifts.

Furthermore, in accordance with some embodiments of the present disclosure, the processor may be configured to: (i) retrieve, a plurality of forecasts and corresponding schedules of working-shifts, from the database of a plurality of agents with respective plurality of scheduled-working-shifts; (ii) analyze the retrieved forecasts, by a processor, by monitoring net-staffing-levels to identify one or more time-intervals, in the retrieved forecasts, which have a staffing variance; (iii) detect one or more agents that will most likely accept one or more time-intervals from the identified one or more time-intervals to store the one or more agents in the database of a plurality of agents with respective plurality of scheduled-working-shifts; (iv) retrieving each detected agent from the database of a plurality of agents with respective plurality of scheduled-working-shifts to create a working-opportunity to amend staffing-variance in one or more time-intervals; and (v) reaching out each detected agent, by broadcasting the created working-opportunity to a computerized-device of corresponding agent to be presented via a display unit, that is associated to the computerized-device.

### BRIEF DESCRIPTION OF THE DRAWINGS

FIG. 1A schematically illustrates a high-level workflow of a method for handling staffing variances in a contact center;

FIG. 1B schematically illustrates a high-level workflow of a technical solution for handling FIG. 1B schematically illustrates a high-level workflow of a technical solution for handling staffing variances, in a contact center, in accordance with some embodiments of the present disclosure

FIGS. 2A-2B are a high-level workflow of a computerized-method for managing staffing variances, in a contact center, in accordance with some embodiments of the present disclosure;

FIG. 3 is a high-level diagram of a computerized-system for managing staffing variances, in a contact center, in accordance with some embodiments of the present disclosure;

FIG. 4A illustrates an example of components used for an implementation of a computerized-method for managing staffing variances, in a contact center, in accordance with some embodiments of the present disclosure;

FIG. 4B illustrates an example of a workflow of a computerized-method for managing staffing variances, in a contact center, in accordance with some embodiments of the present disclosure;

FIG. 5 illustrates a dashboard view of forecasts and gaps in net staffing levels, in accordance with some embodiments of the present disclosure;

FIG. 6 illustrates an example of rules-based interface that can be used by workforce managers to set thresholds to be used by the system, in accordance with some embodiments of the present disclosure; and

FIG. 7 illustrates an example of a notification received by the agent in a mobile app for an extra hours opportunity, in accordance with some embodiments of the present disclosure.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

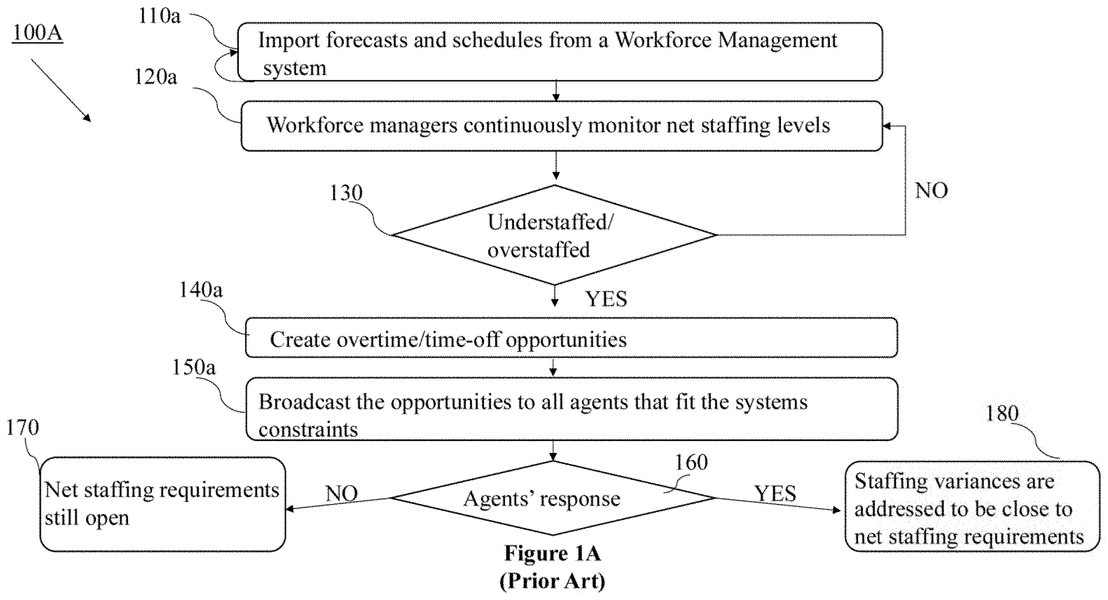

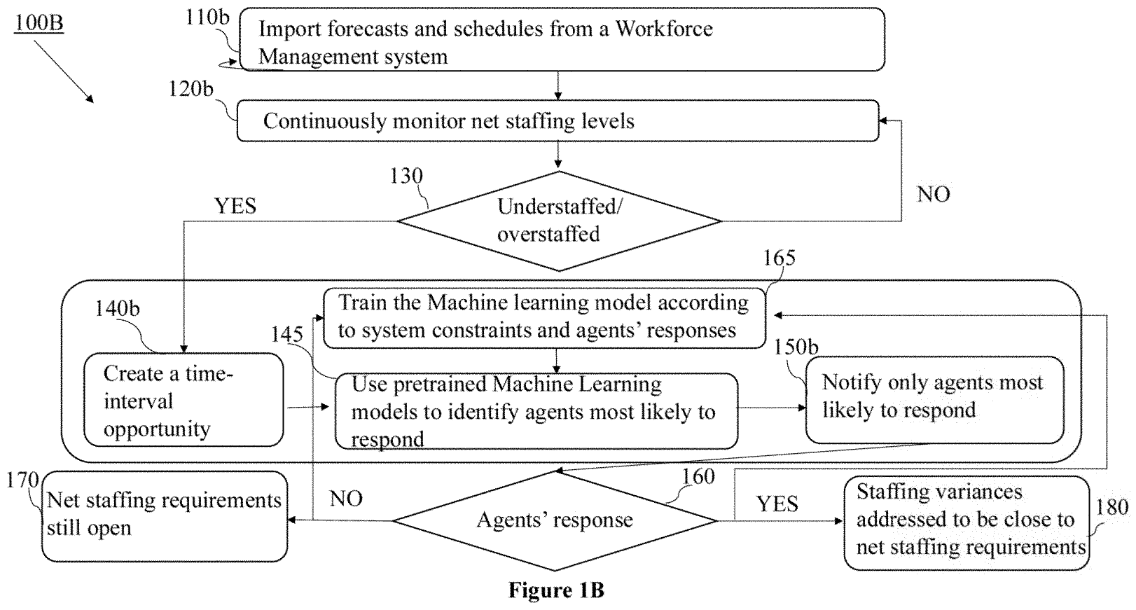

FIG. 1A schematically illustrates a high-level workflow of a method for handling staffing variances, in a contact center 100A.

An analysis on some enterprise customers found that the turnaround time of identifying a staffing variance, then creating recommendation of agents and getting a response back, is huge. Most of the time, either agents do not respond or do not accept the opportunity which delays addressing the staffing gaps. In other words, the recommendation of agents didn't include agents, which are most likely to accept the opportunity to work extra hours or to take time-off to overcome the staffing variance.

As part of the daily activities, workforce managers have to continuously monitor and evaluate staffing variances, i.e., understaffed or overstaffed working shifts that results in either the need for more agents than scheduled or let few agents take time-off. From the agents' aspect, it means opportunities for extra hours or time off. Based on the requirement, a workforce manager has to identify the probable list of agents who can be contacted for the extra hours or time-off. The process of identification of the probable list of agents may take away precious time, that can be better used for other purposes. Therefore, the challenge is twofold; identifying time-intervals having staffing variance and identifying and reaching out to agents that are most likely to accept extra hours or time-off opportunities with lesser turnaround time, for better engagement of the agents.

Commonly, a contact center requires to forecast call volumes and then the contact center generates shift information, which is called schedule generation, with agent allocation to adequately address the forecasted call volumes. Frequent forecasts are required and a consideration of dynamic changes to call volumes in the contact center, to ensure that the workforce managers can take corrective actions to address the gaps with net staffing level, because any gap with net staffing level is a loss to the contact center and it severely impacts the Service Level Agreement (SLA) of the contact center.

Existing solutions simply broadcast the opportunities as notifications to a computerized device of each agent. The notifications are sometimes treated by the agents as spam as the existing solutions don't consider the agents' interests and preferences. Current solutions continuously import forecasts and schedules from a Workforce Management (WFM) system 110a. Then, workforce managers continuously monitor net staffing levels 120a. When there is a time-interval that is understaffed or overstaffed 130, they create an overtime or time-off opportunities 140a, to overcome the staffing variance and then they broadcast the opportunities to all agents that fit the systems constraints 150a.

The agents that receive the broadcasted opportunities may response 160 by rejecting the opportunities or not responding, thus net staffing requirements may still remain open 170. When the agents positively response to the broadcasted opportunities, the staffing variances are addressed to be close to net staffing requirements 180.

For example, currently, in a day in a contact center where the call volume has suddenly spiked up and hence requires more agents to be available to work extra time than the number of agents which were scheduled for the working shift. To address this understaffed situation the workforce manager may send out overtime opportunities to a set of agents in the system. The agents may choose to accept or reject the opportunity, based on their preference. But, if the requirement was for 100 agents and only 20 of them have positively responded, the workforce manager must then again send a request to another batch of agents or reach out to them manually. This may result in time loss and the workforce managers may not be able to fulfill the need of the hour.

Accordingly, there is a need for a technical solution for managing staffing variances in a contact center to ensure optimum net staffing level so that contact centers can meet Service Level Agreements (SLA)s and provide better service to their end customers.

The needed technical solution should further improve agents' engagement to match the dynamic change in demand for contact centers.

FIG. 1B schematically illustrates a high-level workflow of a technical solution for handling staffing variances, in a contact center 100B, in accordance with some embodiments of the present disclosure.

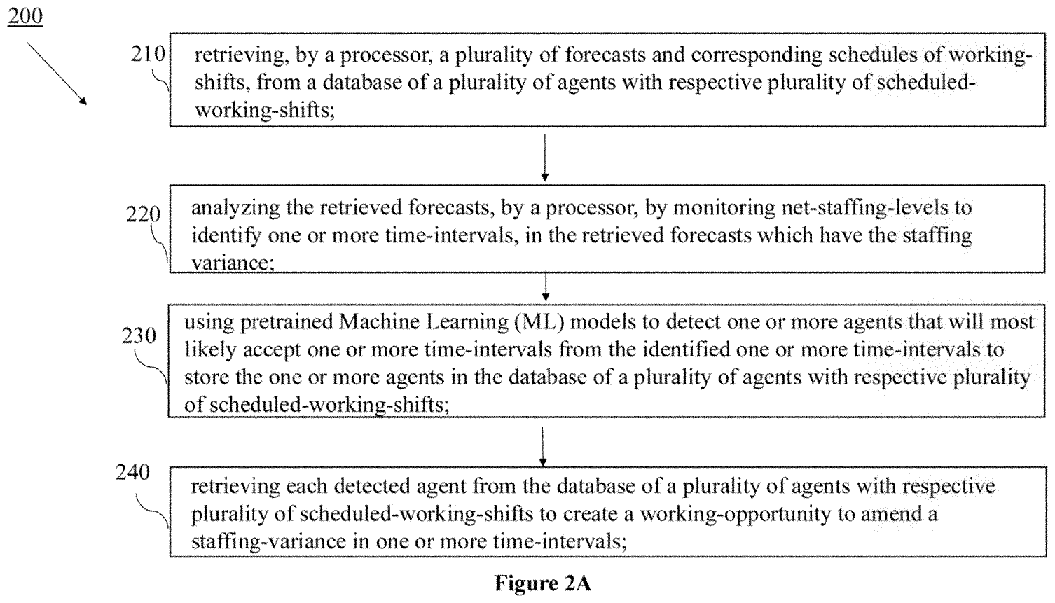

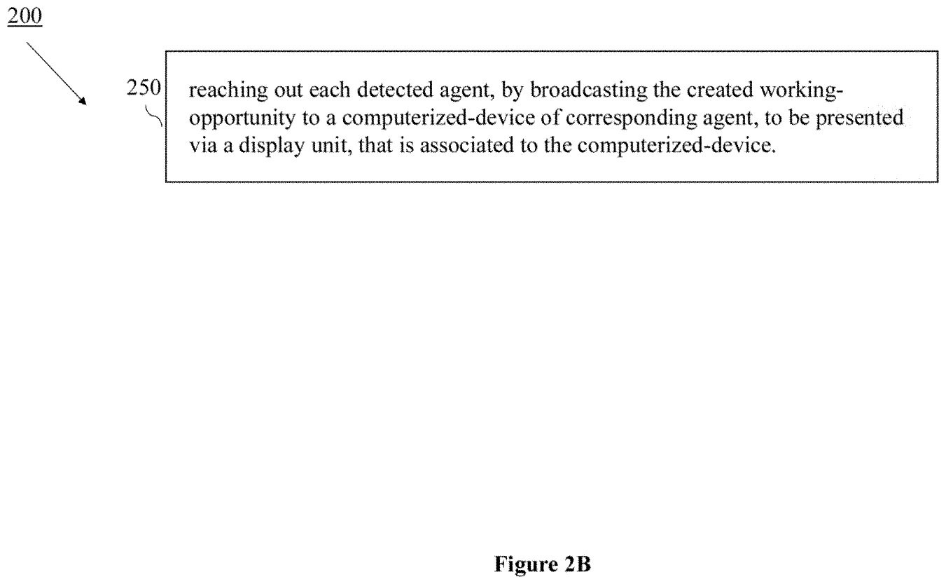

According to some embodiments of the present disclosure, the technical solution 100B may be implemented by a computerized-method, such as the computerized-method for managing staffing variances 200 in FIGS. 2A-2B.

According to some embodiments of the present disclosure, the technical solution 100B may continuously import forecasts and schedules from a Workforce Management system 110b and continuously monitor net staffing levels 120b. When there is an understaffed or overstaffed time interval 130, creating a time-interval opportunity 140b.

According to some embodiments of the present disclosure, using pretrained Machine learning (ML) model to identify agents which are most likely respond 145 to the created time-interval opportunity.

According to some embodiments of the present disclosure, the ML based approach, aims to address the gap between net staffing levels in a time-interval and current staffing levels, by looking at the constraints defined with the system along with agents' previous responses to make a more accurate prediction of agents that can be targeted and most likely will accept the opportunity. A continuous learning involved where new data may be fed to the ML algorithms of the ML model to train the model and fine-tune its prediction to be in line with changing trends. The new data may be agents' response 160 to the created time-interval opportunity. The ML models may be trained according to system constraints and agents' responses 165 to identify agents most likely to respond 145.

According to some embodiments of the present disclosure, system constraints may be for example, (i) proficiency level of the agent, e.g., the agent's rank in relation to other agents, based on proficiency, (ii) response time, e.g., how quickly the agent must respond to offers for extra hours or time off, (iii) reach out success ratio of the agent. e.g., percentage of successful times EEM component has received response from the agent in comparison to the total number of times EEM contacted the agent; (iv) number of reach outs in a preconfigured period of time, e.g., The total number of times EEM contacted the agent during the current week; (v) employment status of the agent, e.g., whether the agent works full-time or part-time; (vi) weekly maximum overtime hours, e.g., maximum number of overtime hours that the contact center allow an agent to work in a week; (vii) weekly minimum and maximum number of hours for employment status, e.g., the minimum or maximum number of hours you allow full-time agents to work in a single week or the minimum or maximum number of hours you allow part-time agents to work in a single week. (viii) daily minimum and maximum number of hours, e.g., the minimum or maximum number of hours you allow agents to work in a single day; (ix) seniority of the agent, e.g., how long the agent has worked for the contact center, based solely on start date; (x) last reach out timestamp, e.g. it may be used for a round robin approach. It may sort agents by when EEM component most recently contacted them with a working opportunity; and (xi) number of hours missed in a shift for extra hours, e.g., the number of hours an agent can be absent for the day and still be considered for an extra hours opportunity.

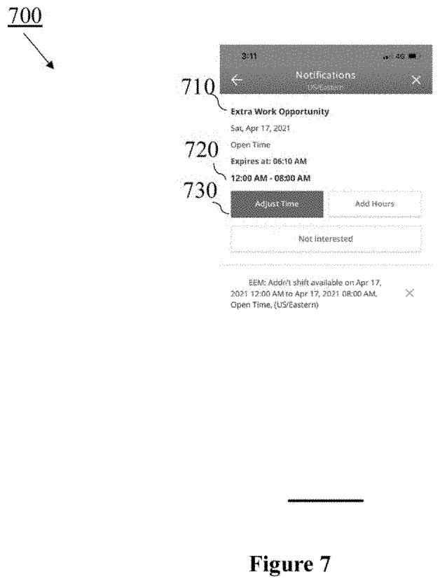

According to some embodiments of the present disclosure, the computerized-method for handling staffing variances, in a contact center 100B may notify only agents which are most likely to respond 150b. The response is to a notification for working opportunity that may include one or more time-intervals as shown in example 700 in FIG. 7.

According to some embodiments of the present disclosure, when agents respond, the response may be recorded and stored in a data store, thus a record of all types of responses from agents in the past may be used for training of the ML models to create a recommendation of agents who are most probable to accept each opportunity.

According to some embodiments of the present disclosure, the recommendation may consider multiple attributes like skill preferences of a communication channel, day and time preference, their responses and the like. Thus, the computerized-method for handling staffing variances, in a contact center 100B, may reach out to maximum agents which may participate in the opportunity and accept it, and automatically adjust the staffing levels to address the understaffing or overstaffing situation, the computerized-method for handling staffing variances, in a contact center 100B, may further implement the computerized-method for managing staffing variances, in a contact center 200 in FIGS. 2A-2B.

FIGS. 2A-2B are a high-level workflow of a computerized-method for managing staffing variances, in a contact center 200, in accordance with some embodiments of the present disclosure.

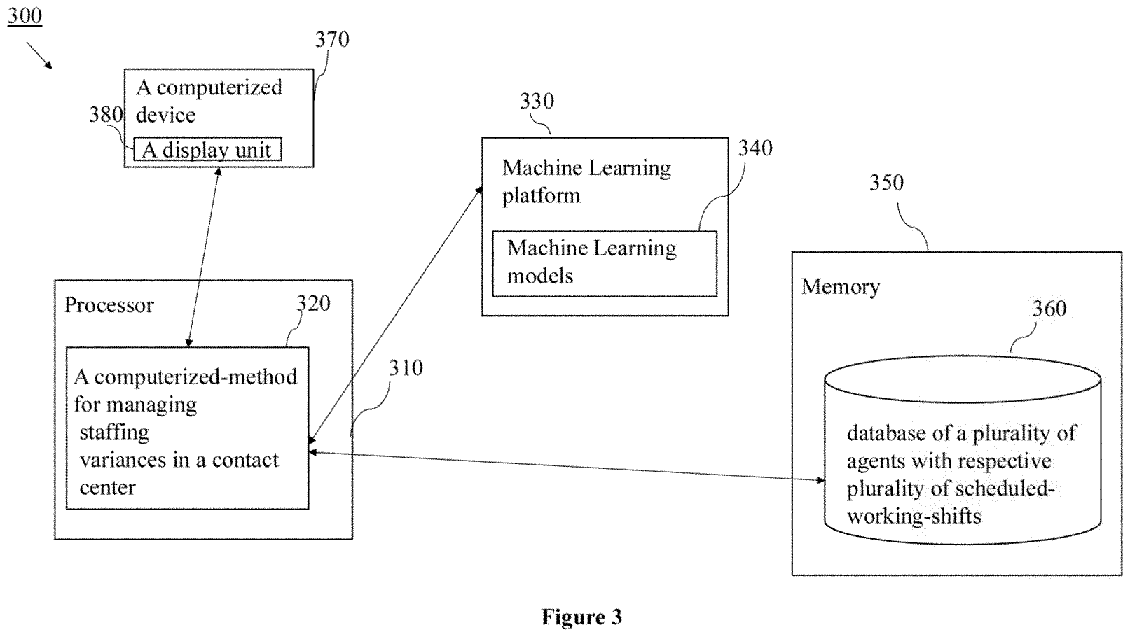

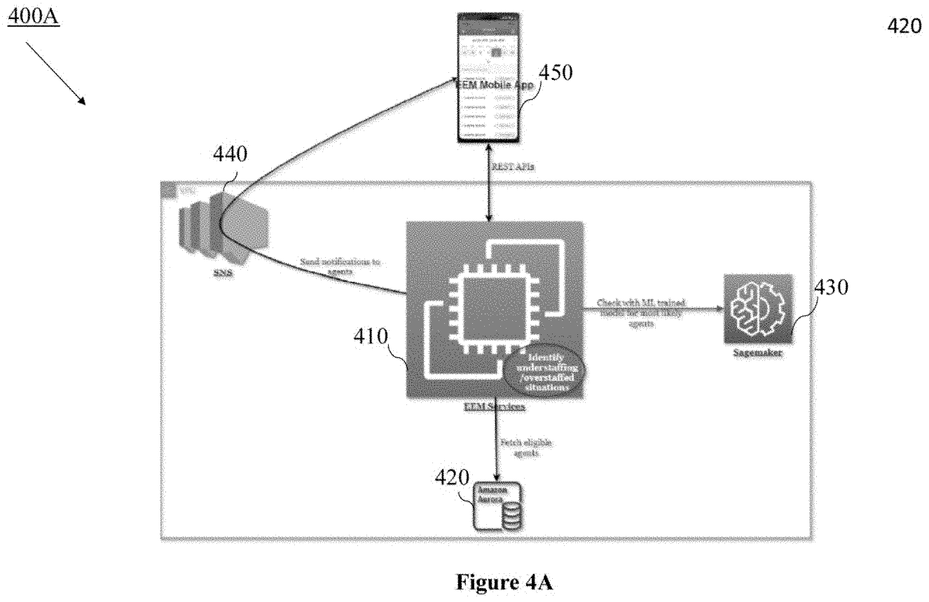

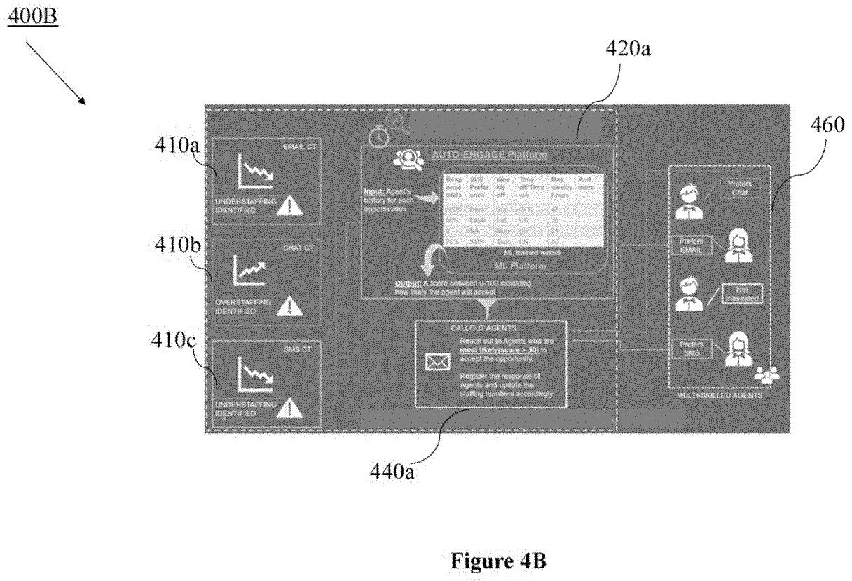

According to some embodiments of the present disclosure, operation 210 may comprise retrieving, by a processor, a plurality of forecasts and corresponding schedules of working-shifts, from a database of a plurality of agents with respective plurality of scheduled-working-shifts. The database of a plurality of agents with respective plurality of scheduled-working-shifts may be a data store, such as database of a plurality of agents with respective plurality of scheduled-working-shifts 360 in FIG. 3 or such as Amazon Aurora 420 in FIG. 4A.

According to some embodiments of the present disclosure, operation 220 may comprise analyzing the retrieved forecasts, by a processor, by monitoring net-staffing-levels to identify one or more time-intervals, in the retrieved forecasts which have the staffing variance. The analysis may be operated in any Workforce Management component, which helps to manage, track employee work and employee schedules and the like. For example, the Workforce Management component, a Workforce Management component, such as Employee Engagement Manager (EEM) services 410 in FIG. 4A.

According to some embodiments of the present disclosure, operation 230 may comprise using pretrained Machine Learning (ML) models to detect one or more agents that will most likely accept one or more time-intervals from the identified one or more time-intervals to store the one or more agents in the database of a plurality of agents with respective plurality of scheduled-working-shifts.

According to some embodiments of the present disclosure, the pretrained ML models may be developed in an ML platform, such as Sagemaker 430 in FIG. 4A, which is a development platform for ML models.

According to some embodiments of the present disclosure, the database of a plurality of agents with respective plurality of scheduled-working-shifts, may be implemented in a component, such as Amazon Aurora (Aurora) 420 in FIG. 4, which is a fully managed relational database engine that's compatible with MySQL and PostgreSQL.

According to some embodiments of the present disclosure, operation 240 may comprise retrieving each detected agent from the database of a plurality of agents with respective plurality of scheduled-working-shifts to create a working-opportunity to amend a staffing-variance in one or more time-intervals.

According to some embodiments of the present disclosure, operation 250 may comprise reaching out each detected agent, by broadcasting the created working-opportunity to a computerized-device of corresponding agent, to be presented via a display unit, that is associated to the computerized-device. The computerized device may be a computerized device such as computerized device 370 in FIG. 3.

According to some embodiments of the present disclosure, the computerized device may be at least one of: a mobile device, a tablet, a laptop or a desktop. When the computerized-device is a mobile device, the display unit, that is associated to the computerized-device, may be a display unit of a mobile device, presenting EEM mobile app, such as EEM mobile app 450 in FIG. 4A. The EEM mobile app may present a notification to an agent via an Application Programming Interface (API) of Representational State Transfer (REST). The notification may be, for example, an extra work opportunity in Apr. 17, 2021 from 12:00 am-08:00 am, as shown in example 700 in FIG. 7, which is described in detail below.

According to some embodiments of the present disclosure, the reaching out by the notification may be through SMS or email or push notifications with an expiry time to respond.

According to some embodiments of the present disclosure, the broadcasted created working-opportunity may be sent to the agents as a notification by a component, such as Amazon SNS 440 in FIG. 4A. Amazon SNS is a notification service provided as part of Amazon Web Services, which provides an infrastructure for a mass delivery of messages.

FIG. 3 is a high-level diagram of a computerized-system for managing staffing variances, in a contact center 300, in accordance with some embodiments of the present disclosure.

According to some embodiments of the present disclosure, the system, such as computerized-system for managing staffing variances, in a contact center 300, which may implement a computerized method, such as computerized-method for managing staffing variances, in a contact center 320 and such as computerized-method for managing staffing variances, in a contact center 200 in FIGS. 2A-2B, may include a processor 310, a platform for Machine Learning (ML) models 330 for developing and running ML models 340 and a database of a plurality of agents with respective plurality of scheduled-working-shifts 360 which may be stored in memory 350.

According to some embodiments of the present disclosure, the platform for ML models 330 may be implemented in a component such as Sagemaker 430 in FIG. 4A, which is a development platform for ML models.

According to some embodiments of the present disclosure, the computerized-method for managing staffing variances, in a contact center 320, such as computerized-method for managing staffing variances, in a contact center 200 in FIGS. 2A-2B, may be broadcasting a created working-opportunity to a computerized-device of corresponding agent, such as computerized device 370 to be presented via a display unit, such as display unit 380, that is associated to the computerized-device 370.

According to some embodiments of the present disclosure, the computerized device 370 may be at least one of: a mobile device, a tablet, a laptop or a desktop as detailed above.

According to some embodiments of the present disclosure, the broadcasted working opportunity may be a notification that is displayed on the display unit 380 of the computerized device 370 by an Employee Engagement Manager (EEM) application. The notification may be, for example, an extra work opportunity in Apr. 17, 2021, from 12:00 am-08:00 am, as shown in example 700 in FIG. 7, which is described in detail below.

According to some embodiments of the present disclosure, the database of a plurality of agents with respective plurality of scheduled-working-shifts 360 may be implemented by a component, such as Amazon Aurora (Aurora) 420 in FIG. 4.

FIG. 4A illustrates an example of components used for an implementation 400A of a computerized-method for managing staffing variances, in a contact center, in accordance with some embodiments of the present disclosure.

According to some embodiments of the present disclosure, the implementation 400A of a computerized-method for managing staffing variances, in a contact center, may be by an Employee Engagement Manager (EEM) services component 410.

According to some embodiments of the present disclosure, the services that identify the understaffing/overstaffing situations and leverage the Machine Learning (ML) trained models for predicting the agents most likely to positively respond to the notification and accept the work opportunity. The EEM services component 410 may reach out each predicted agent, by broadcasting the created working-opportunity to a computerized-device of corresponding agent, to be presented via a display unit, that is associated to the computerized-device.

According to some embodiments of the present disclosure, the broadcasted working-opportunities may be sent out to the agents as notifications by using Amazon Web Services (AWS) Simple Notification Service (SNS) component 440. The AWS SNS component 440 may be used to send out push notifications to the EEM application, such as EEM mobile app, which is used to view and respond to opportunities.

According to some embodiments of the present disclosure, the agents may receive the notifications in their computerized device, such as computerized device 370 in FIG. 3. The computerized device may be a mobile device that is running an EEM mobile app 450.

According to some embodiments of the present disclosure, the Machine Learning (ML) platform to train the model that may be used to make predictions as to agent who are most likely accept a working opportunity may be a Sagemaker service 430. The Sagemaker service 430 may be used to train the ML models with data every preconfigured time e.g., a week and deploy a new model to fine tune the predictions. The data may be agents' responses to working opportunities, which are overtime or time-off.

According to some embodiments of the present disclosure,

FIG. 4B illustrates an example 400B of a workflow of a computerized-method for managing staffing variances, in a contact center, in accordance with some embodiments of the present disclosure.

According to some embodiments of the present disclosure, when understaffing in email as communication channel 410a or overstaffing in chat as communication channel 410b or understaffing in Short Message Service (SMS) 410c, may be identified, a computerized-method, such as the computerized method for managing staffing variances in a contact center 200 in FIGS. 2A-2B or such as computerized method for managing staffing variances in a contact center 320 in FIG. 3, may analyze the retrieved forecasts, by a processor, by monitoring net-staffing-levels to identify one or more time-intervals, in the retrieved forecasts which have the staffing variance e.g., 410a, 410b and 410c.

According to some embodiments of the present disclosure, a computerized-method, such as the computerized method for managing staffing variances in a contact center 200 in FIGS. 2A-2B or such as computerized method for managing staffing variances in a contact center 320 in FIG. 3, may use pretrained Machine Learning (ML) models to detect one or more agents that will most likely accept one or more time-intervals from the identified one or more time-intervals to store the one or more agents in the database of a plurality of agents with respective plurality of scheduled-working-shifts. For example, according to agents' history as to working opportunities to overcome the staffing variance 420a.

According to some embodiments of the present disclosure, as shown in table 420a, the pretrained ML model may rank agents with a higher response rate e.g., response rate of 100% with one or more matching attributes of preferred skill, weekly off, max weekly hours, time-on/time-off opportunity type and many others, higher than other agents whose response rate is lower e.g., response rate of 50% or less with one or more matching attributes.

According to some embodiments of the present disclosure, the detecting of one or more agents that will most likely accept one or more time-intervals from the identified one or more time-intervals may be performed by: for each time-interval of the identified one or more time-intervals: retrieving one or more agents that match contact-center system requirements of the time-interval from the database of a plurality of agents with respective plurality of scheduled-working-shifts. Then, providing the retrieved one or more agents to pretrained Machine Learning (ML) models, to predict a rank of each agent to accept the time-interval. The rank may be a score between ‘0’ and ‘100’ which may indicate how likely an agent will accept a working opportunity.

According to some embodiments of the present disclosure, one or more agents having a predicted rank above a preconfigured threshold may be stored in the database of a plurality of agents with respective plurality of scheduled-working-shifts, such as the database of a plurality of agents with respective plurality of scheduled-working-shifts 360 in FIG. 3.

According to some embodiments of the present disclosure, the ML models are trained to predict the rank of each agent to accept the time-interval based on working-opportunity parameters. The working-opportunity parameters may include at least one of: (i) working-opportunity start-time; (ii) working-opportunity end-time; (iii) shift start date and time; (iv) shift end date and time; (v) broadcasting communication channel, e.g., emails or SMS or push notifications; (vi) status of working-opportunity; (vii) response time, e.g., time-interval within which response is expected; (viii) time zone of working-opportunity; (ix) type of working opportunity, e.g., extra hours, unpaid, overtime, surge; (x) disclaimer accepted, e.g., if the agent has accepted the disclaimer; and (xi) activity code.

According to some embodiments of the present disclosure, the agents having a predicted rank above a preconfigured threshold may be reached out by a notification such as notification 700 in FIG. 7, sent to their computerized device. For example, agents having a predicted score that is above 50 to accept the opportunity 440a.

According to some embodiments of the present disclosure, a response as to each notification, e.g., broadcasted working opportunity from one or more computerized-devices of agents may be received and may be provided to the ML models for training purposes. Furthermore, the staffing numbers may be updated according to the agents' responses 440a.

According to some embodiments of the present disclosure, according to the agents' response, agents' preferences 460 may be for example preferred communication channel chat or email or SMS.

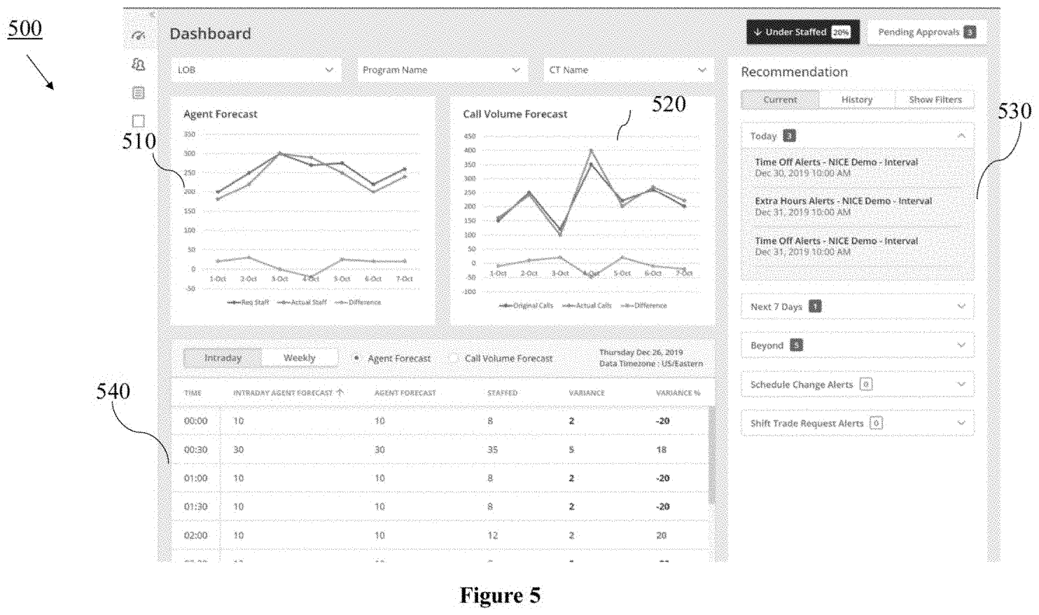

FIG. 5 illustrates a dashboard view of forecasts and gaps in net staffing levels 500, in accordance with some embodiments of the present disclosure.

According to some embodiments of the present disclosure, a user such as a workforce administrator may be alerted for staffing variances through a dashboard, such as Real Time Coordinator (RTC) dashboard 500 for each interval of current day and future days. There may be also notifications as to all recommendations sent to agents through the day.

According to some embodiments of the present disclosure, an agent forecast 510 over a period of time, may be presented via the dashboard 500. The agent forecast 510 is the Agent forecast view in graphical format depicting a daily comparison of the required staffing numbers with the actual staffed numbers and the difference to help understand the staffing variance.

According to some embodiments of the present disclosure, a call volume forecast 520 over a period of time, may be presented via the dashboard 500. The call volume forecast 520 is the Call volume forecast view depicting a daily comparison of the original forecasted calls with the actual calls and the difference.

According to some embodiments of the present disclosure, gaps in net staffing levels 540 may be also presented via the dashboard 500. The gaps in net staffing levels 540 is the forecast view of intraday or future day with a detailed interval wise information. This may help workforce managers to review staffing data at each 30-minute time-interval.

According to some embodiments of the present disclosure, a system such as computerized-system for managing staffing variances, in a contact center 300 in FIG. 3 may identify staffing variances and reach out to agents for time off and overtime opportunities. The workforce managers may be alerted of all such recommendations generated by the system so that they may be aware of it. The workforce managers may also review any recommendation that was generated in past.

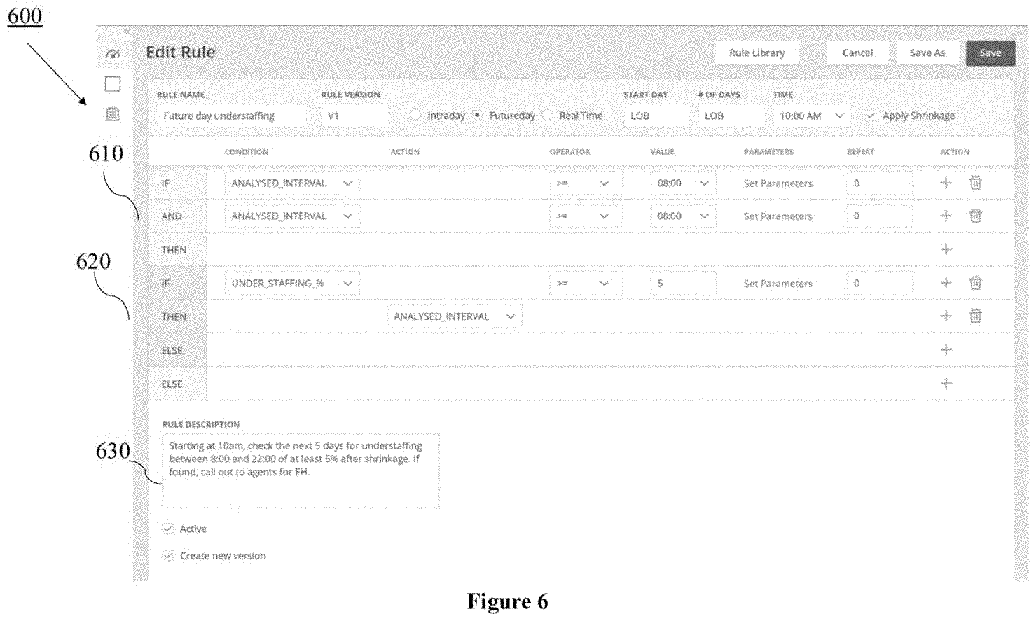

FIG. 6 illustrates an example of rides-based interface 600 that can be used by workforce managers to set thresholds, in accordance with some embodiments of the present disclosure.

According to some embodiments of the present disclosure, users such as administrators may control the preconfigured thresholds which above it then working opportunities to agents who are most probable to accept it may be sent. The preconfigured thresholds may be used by the system, such as computerized-system for managing staffing variances, in a contact center 300 in FIG. 3 to control what limits of staffing variance should be used to flag a time-interval as understaffed or overstaffed and generate working opportunities for the same.

According to some embodiments of the present disclosure, the administrators may also control the request filters, such as average handling time, agent proficiency, etc. through the rule creation screens.

According to some embodiments of the present disclosure, a rule description, such as 630 may be presented via rile-based interface 600. The rule description may be “starting at 10 am, check the next 5 days for understaffing between 8:00 and 22:00 of at least 5% after shrinkage. If found, call out to agents for Extra Hours (EH)”.

FIG. 7 illustrates an example 700 of a notification received by the agent in a mobile app for an extra hours' opportunity, in accordance with some embodiments of the present disclosure.

According to some embodiments of the present disclosure, a notification 700 of an extra hour work opportunity, such as extra work opportunity 710 for Saturday, Apr. 17, 2021, may be sent to most likely to accept agents.

According to some embodiments of the present disclosure, the notification 700 may expire at 06:10 am. The notification expiration time may be commonly 30 minutes which may be configurable. In example 700, the notification was sent at 05:40 AM as per the agent's local time

According to some embodiments of the present disclosure, an agent that may receive the notification 700 may

According to some embodiments of the present disclosure, when the response of the agent to the notification 700 is ‘accept’, adjustment of time span of the working-opportunity may be enabled.

For example, the agent may be enabled to adjust the time interval 730 of 12:00 am-08:00 am 720.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

What is claimed:

1. A computerized method for managing staffing variances in a contact center, the computerized method comprising:
(i) retrieving, by a processor, a plurality of forecasts and corresponding schedules of working-shifts, from a database of a plurality of agents with respective plurality of scheduled-working-shifts;
(ii) analyzing the retrieved forecasts, by a processor, by monitoring net-staffing-levels to identify one or more time-intervals, in the retrieved forecasts which have the staffing variance;
(iii) using pretrained Machine Learning (ML) models to detect one or more agents that will most likely accept one or more time-intervals from the identified one or more time-intervals to store the one or more agents in the database of a plurality of agents with respective plurality of scheduled-working-shifts;
(iv) retrieving each detected agent from the database of a plurality of agents with respective plurality of scheduled-working-shifts to create a working-opportunity to amend staffing-variance in one or more time-intervals; and
(v) reaching out each detected agent, by broadcasting the created working-opportunity to a computerized-device of corresponding agent, to be presented via a display unit, that is associated to the computerized-device.

2. The computerized method of claim 1, wherein the detecting of one or more agents that will most likely accept one or more time-intervals from the identified one or more time-intervals is performed by:
for each time-interval of the identified one or more time-intervals:
(i) retrieving one or more agents that match contact-center system requirements of the time-interval from the database of a plurality of agents with respective plurality of scheduled-working-shifts;
(ii) providing the retrieved one or more agents to pretrained Machine Learning (ML) models, to predict a rank of each agent to accept the time-interval; and
(iii) storing one or more agents having a predicted rank above a preconfigured threshold in the database of a plurality of agents with respective plurality of scheduled-working-shifts.

3. The computerized method of claim 1, wherein the retrieving of the one or more agents that match contact-center system requirements of the time-interval is performed based on agent related parameters, wherein the agent related parameters include at least one of:
(i) proficiency level;
(ii) response time;
(iii) reach out success ratio;
(iv) number of reach outs in a preconfigured period of time;
(v) employment status;
(vi) weekly maximum overtime hours;
(vii) weekly minimum and maximum number of hours for employment status;
(viii) daily minimum and maximum number of hours;
(ix) seniority;
(x) last reach out timestamp; and
(xi) number of hours missed in a shift for extra hours.

4. The computerized method of claim 1, wherein the broadcasting of the created working-opportunity is via at least one communication channel.

5. The computerized method of claim 3, wherein the at least one communication channel includes: email, Short Message Service (SMS), chat messaging, push notification and notifications within an agent web portal.

6. The computerized method of claim 1, wherein the ML models are trained to predict the rank of each agent to accept the time-interval based on working-opportunity parameters, wherein the working-opportunity parameters include at least one of:
(i) working-opportunity start-time;
(ii) working-opportunity end-time;
(iii) shift start date and time;
(iv) shift end date and time;
(v) broadcasting communication channel;
(vi) status of working-opportunity;
(vii) response time;
(viii) time zone of working-opportunity;
(ix) disclaimer accepted; and
(x) activity code.

7. The computerized method of claim 1, wherein the broadcasted working-opportunity includes at least one of: (i) date; (ii) time; (iii) activity type; and (iv) response options.

8. The computerized method of claim 7, wherein the response options are limited by a preconfigured period of time.

9. The computerized method of claim 1, wherein the working opportunity is overtime or time-off.

10. The computerized method of claim 1, wherein time intervals having the staffing variance are time intervals which are understaffed or overstaffed.

11. The computerized method of claim 1, wherein the monitoring of net staffing levels is performed by a computerized system that is evaluating gaps with respect to net staffing levels for each interval.

12. The computerized method of claim 1, wherein the computerized method is further receiving a response as to each broadcasted working opportunity from one or more computerized-devices of agents.

13. The computerized method of claim 12, wherein the computerized method is further providing the response to the ML models for training thereof and updating staffing numbers in each time-interval.

14. The computerized method of claim 12, wherein the response is one of: ‘accept’, ‘reject’ or ‘no response’.

15. The computerized method of claim 14, wherein when the response is ‘accept’, the computerized method is further enabling adjustment of time span of the working-opportunity.

16. A computerized system for managing staffing variances in a contact center, the computerized system comprising:
a processor;
a platform for Machine Learning (ML) models;
a database of a plurality of agents with respective plurality of scheduled-working-shifts, said processor is configured to:
(i) retrieve, a plurality of forecasts and corresponding schedules of working-shifts, from the database of a plurality of agents with respective plurality of scheduled-working-shifts;
(ii) analyze the retrieved forecasts, by a processor, by monitoring net-staffing-levels to identify one or more time-intervals, in the retrieved forecasts, which have a staffing variance;
(iii) using pretrained Machine Learning (ML) models to detect one or more agents that will most likely accept one or more time-intervals from the identified one or more time-intervals to store the one or more agents in the database of a plurality of agents with respective plurality of scheduled-working-shifts;
(iv) retrieving each detected agent from the database of a plurality of agents with respective plurality of scheduled-working-shifts to create a working-opportunity to amend staffing-variance in one or more time-intervals; and
(v) reaching out each detected agent, by broadcasting the created working-opportunity to a computerized-device of corresponding agent to be presented via a display unit, that is associated to the computerized-device.
